(19) United States
(12) Patent Application Publication
(10) Pub. No.: US 2019/0291767 A1
(43) Pub. Date: Sep. 26, 2019

(54) STROLLERS WITH MOVABLE LEG RESTS AND RELATED METHODS

(71) Applicant: Kolcraft Enterprises, Inc., Chicago, IL (US)

(72) Inventors: Paul T. Ansani, Chicago, IL (US); Joseph C. Cacciola, Chicago, IL (US)

(21) Appl. No.: 16/228,100

(22) Filed: Dec. 20, 2018

Related U.S. Application Data
(60) Provisional application No. 62/645,696, filed on Mar. 20, 2018.

(51) Int. Cl. B62B 7/14

(52) U.S. Cl. CPC B62B 7/145; B62B 2205/30; B62B 2202/42

(57) ABSTRACT

Example strollers with movable legs rests and related methods are described herein. An example stroller includes a frame, a seat carried by the frame, the seat having a seat bottom and a seat back, and a leg rest rotatably coupled to the seat bottom. The leg rest is rotatable to an upward position in which the leg rest is angled upward from the seat bottom and forms a c-shaped contour with the seat bottom and the seat back to support a car seat.

### RELATED APPLICATION

This patent claims the benefit under 35 U.S.C. § 119(e) of U.S. Provisional Patent Application No. 62/645,696, titled “STROLLERS WITH MOVABLE LEG RESTS AND RELATED METHODS,” filed Mar. 20, 2018, which is hereby incorporated by this reference in its entirety.

### FIELD OF THE DISCLOSURE

This disclosure relates generally to strollers and, more particularly, to strollers with movable leg rests and related methods.

### BACKGROUND

Known strollers include a frame and one or more seats to support child occupants. Some known strollers include mounting hubs or brackets for mounting a car seat to the frame, such that a car seat with matching hubs or brackets can be connected to the stroller and used as a seat for the stroller.

### BRIEF DESCRIPTION OF THE DRAWINGS

FIG. 1 is a perspective view of an example stroller having an example movable leg rest constructed in accordance with the teachings of the disclosure. In FIG. 1, the leg rest is in a lowered (first) position.

FIG. 2 shows the example stroller of FIG. 1 with the leg rest in an extended (second) position.

FIG. 3A shows the example stroller of FIG. 1 with the leg rest in an upward (third) position. FIG. 3A also shows an example car seat that may be placed on a seat of the example stroller.

FIG. 3B shows the example stroller of FIG. 3A supporting the example car seat with the leg rest in the upward (third) position.

FIG. 3C shows an example strap of the example stroller used to secure the example car seat to the example stroller.

FIG. 4A is another perspective view of the example stroller of FIG. 1 with the example leg rest in the extended (second) position.

FIG. 4B shows the leg rest of FIG. 4A with the soft goods removed to expose an internal support frame of the leg rest.

FIG. 5 is a bottom perspective view of the internal support frame of the leg rest of FIG. 4B.

FIG. 6 is a perspective view of a portion of the internal support frame of the leg rest of FIG. 5 and a toothed hub.

FIGS. 7A-7C are side views of a portion of the internal support frame of the leg rest including the toothed hub of FIG. 6. FIGS. 7A-7C show the example leg rest in the lowered (first) position, the extended (second) position, and the upward (third) position, respectively.

FIG. 8 is a bottom perspective of the internal support frame of FIG. 5 showing an alternative example in which a transverse support is used to release the leg rest.

FIG. 9 illustrates an alternative example internal support frame that may be implemented in connection with the example leg rest of FIG. 1.

FIG. 10 illustrates another alternative example internal support frame that may be implemented in connection with the example leg rest of FIG. 1.

FIG. 11 is a flowchart representative of an example method of securing a car seat to a stroller that may be implemented using the example stroller and the example car seat of FIGS. 3A-3C.

The figures are not to scale. Instead, the thickness of the layers or regions may be enlarged in the drawings. In general, the same reference numbers will be used throughout the drawing(s) and accompanying written description to refer to the same or like parts. As used in this patent, stating that any part (e.g., a layer, film, area, region, or plate) is in any way on (e.g., positioned on, located on, disposed on, or formed on, etc.) another part, indicates that the referenced part is either in contact with the other part, or that the referenced part is above the other part with one or more intermediate part(s) located therebetween. Stating that any part is in contact with another part means that there is no intermediate part between the two parts.

### DETAILED DESCRIPTION

Strollers typically include a frame and a seat supported by the frame to receive a child occupant. Some known stroller frames include mounting hubs or brackets for mounting a car seat to the frame. However, this requires specific matching mounts on both the frame and the car seat. Thus, the stroller can only be used with a specific type of car seat. Further, these mounts or brackets can be bulky and complicated to operate.

Disclosed herein are example strollers with movable leg rests that can rotate to an upward position in which the leg rest is used to support a car seat resting on a seat of the stroller. An example stroller disclosed herein includes a leg rest that is rotatably coupled to a seat of the stroller (e.g., to a front of the seat). The seat includes a seat bottom and a seat back. The leg rest can be rotated to an upward position where the leg rest is angled upward from the seat bottom. In this position, the leg rest, the seat bottom, and the seat back form a u- or c-shaped contour for receiving and supporting a car seat or other infant seat/carrier. For example, when the leg rest is in the upward position, a car seat may be placed on the seat of the stroller in a rear-facing direction. The leg rest supports the back of the car seat and/or otherwise prevents the car seat from falling forward out of the seat. Therefore, rather than having to remove the child from the car seat and strap the child into the seat in the stroller, a parent can easily place the entire car seat on the stroller. The stroller, along with the car seat and the child in the car seat, can then be operated as normal to transport the child.

In some examples, the leg rest is lockable in the upward position and/or one or more other positions. For example, the leg rest may also be lockable in an extended position, where the leg rest extends generally outward from the seat bottom, which provides a surface for an occupant to rest his/her legs. In some examples, the leg rest includes a tab or trigger that, when activated (e.g., pulled, pressed) by a user, enables the leg rest to rotate to another position.

In some examples, the car seat is further secured to the stroller via a strap. In some examples, the strap is coupled to the frame of the stroller. In such an example, once the car seat is set on the seat of the stroller, the strap may be wrapped over the top (and/or around another portion) of the car seat. In some examples, the strap includes a connector (e.g., a buckle). In some examples, two straps are coupled to the frame of the stroller than can be connected over the top of the car seat. Additionally or alternatively, the car seat may include one or more straps with connectors. The straps can be wrapped around a portion of the frame of the stroller and coupled together (e.g., beneath the seat bottom). Thus, unlike known strollers that can only operate with specific car seats having matching mounting hubs, the example strollers disclosed herein can be used with many different types of car seats.

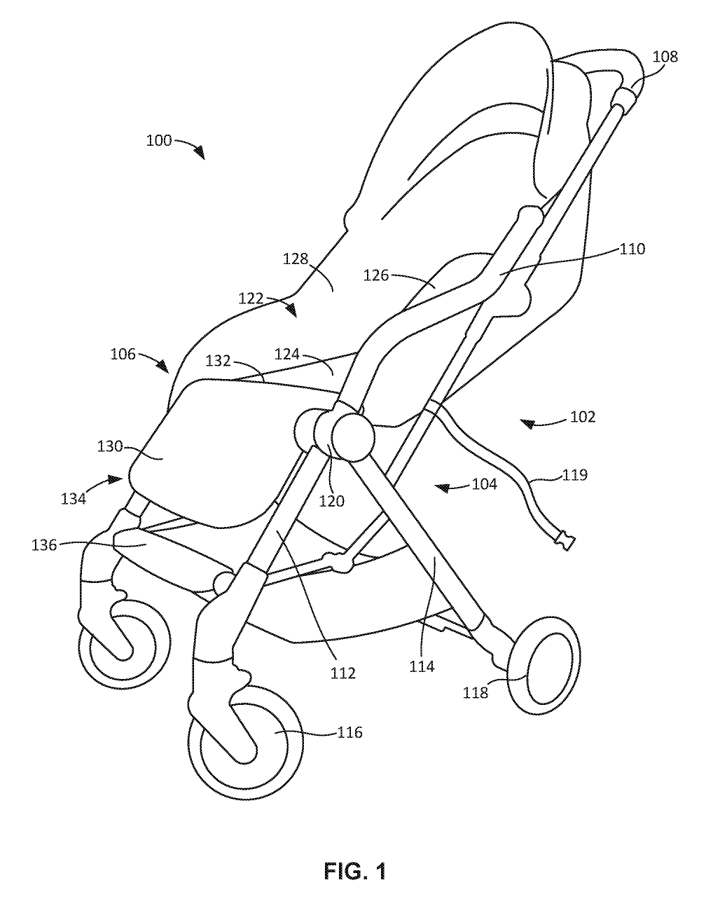

Turning now to the figures, FIG. 1 is a perspective view of an example stroller 100 constructed in accordance with the teachings of this disclosure. The example stroller 100 includes a frame 102 having a first side 104, a second side 106 opposite the first side 104, and a handle 108 (sometimes referred to as a parent handle) coupled to the first and second sides 104, 106. The first side 104 and the second side 106 of the frame 102 include a plurality of frame members and wheels attached to the frame members. In the illustrated example, the first side 104 of the frame 102 includes a side rail 110 coupled (e.g., via a hinge or joint) to the parent handle 108. In this example, the first side 104 of the frame 102 also includes a front leg 112 and a rear leg 114. A front wheel 116 is coupled to the front leg 112, and a rear wheel 118 is coupled to the rear leg 114. In the illustrated example, the stroller 100 includes a first strap 119 coupled to the first side 104 of the frame 102. The first strap 119 may be used to secure a car seat to the example stroller 100, as disclosed in further detail herein.

In the illustrated example of FIG. 1, the side rail 110, the front leg 112, and the rear leg 114 are coupled via a hub 120. In some examples, the side rail 110, the front leg 112, and the rear leg 114 are rotatably coupled at the hub 120 to facilitate folding of the frame 102. In the illustrated example, the second side 106 of the frame 102 is a mirror of the first side 104 and includes identical structures. Thus, to avoid redundancy, a description of the second side 106 is not included herein. Instead, it is understood that any of the structure(s) associated with the first side 104 can likewise be applied to the second side 106. However, in other examples, the first or second sides 104, 106 may include functions or structures not on the other side.

In the illustrated example of FIG. 1, the stroller 100 includes a seat 122 carried by the frame 102. The seat 122 is to support a child occupant. The seat 122 has a seat bottom 124 and a seat back 126. When a child is sitting on the seat 122, the child's bottom contacts the seat bottom 124 and the child's back contacts the seat back 126. The seat 122 includes soft goods 128 (e.g., a fabric covering, etc.) coupled to and carried by the frame 102. The soft goods 128 is supported by one or more internal frame members (disclosed in further detail herein).

The example stroller 100 of FIG. 1 also includes a leg rest 130 (which may be referred to as a foot rest) that is movably coupled to the seat 122. In particular, the leg rest 130 is rotatably (e.g., pivotably) coupled to a front 132 (e.g., a forward edge) of the seat bottom 124. The leg rest 130 is capable of being rotated to and releasably locked at one or more positions. In the illustrated example of FIG. 1, the leg rest 130 is in a lowered position 134 (e.g., a first position). With the leg rest 130 in the lowered position 134, a child's legs (if the child is large enough) would hang down from the front 132 of the seat 122. The back of the child's legs may contact the leg rest 130. In the illustrated example, the stroller 100 includes a foot rest 136 (extending between the front legs) that the child may rest his/her feet on. The leg rest 130 may be in the lowered position 134 when the occupant of the stroller 100 is entering/exiting the seat 122, for example. In the illustrated example of FIG. 1, the leg rest 130 includes soft goods (e.g., a cover), which, in this example, is part of the soft goods 128 that forms the seat 122. In other examples, the soft goods of the leg rest 130 may be separate from the soft goods 128 of the seat 122.

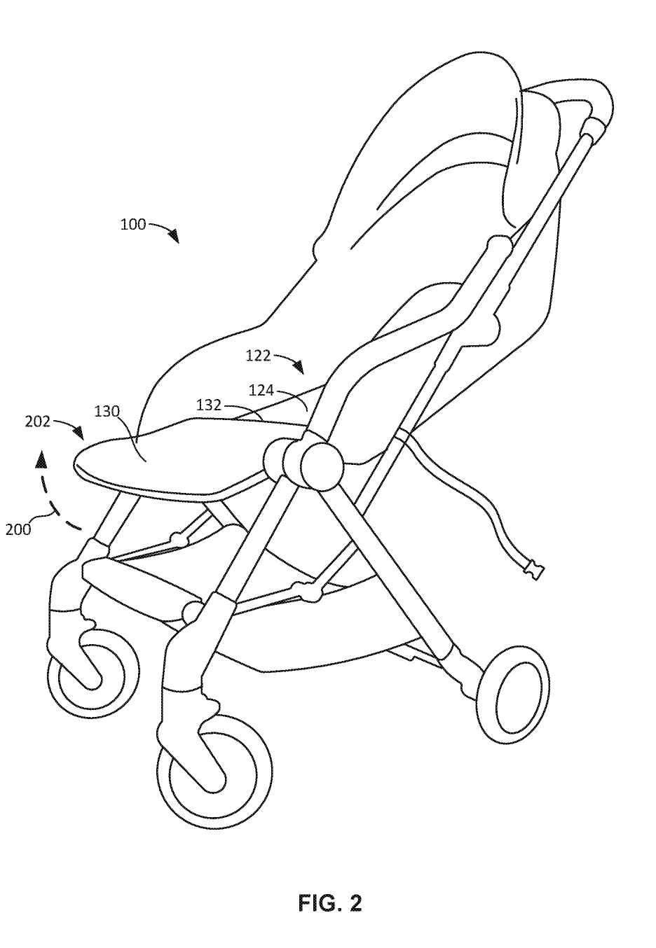

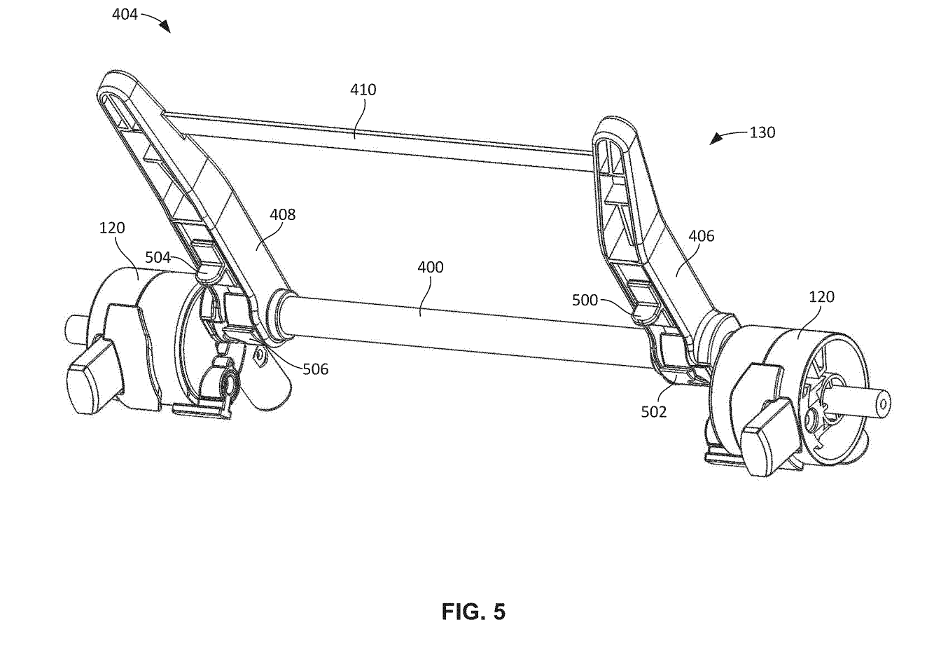

FIG. 2 shows the leg rest 130 after being rotated upward (in the direction of arrow 200) to an extended position 202 (e.g., a second or middle position). In the extended position 202, the leg rest 130 of the example stroller 100 extends generally outward (e.g., horizontal) from the front 132 of the seat bottom 124 of the seat 122. In this position, the leg rest 130 can be utilized to support the legs of an occupant in the stroller 100. In some examples, the leg rest 130 is lockable in this position and/or otherwise prevented from rotating downward. An example latching mechanism that may be used to secure the leg rest 130 in the extended position 202 is disclosed in further detail in connection with FIGS. 5-7C.

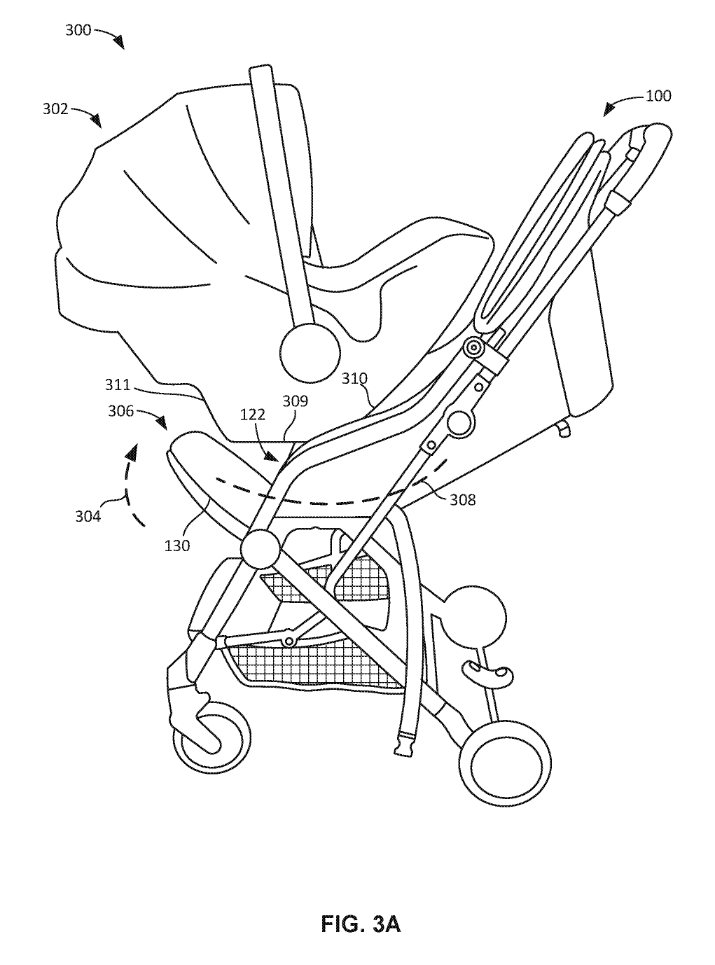

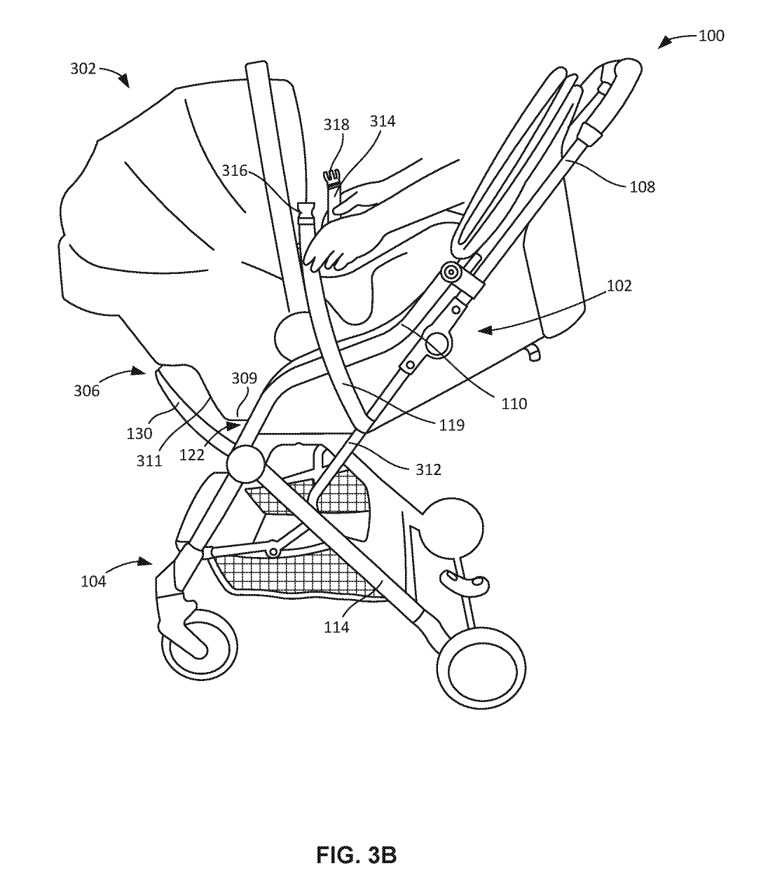

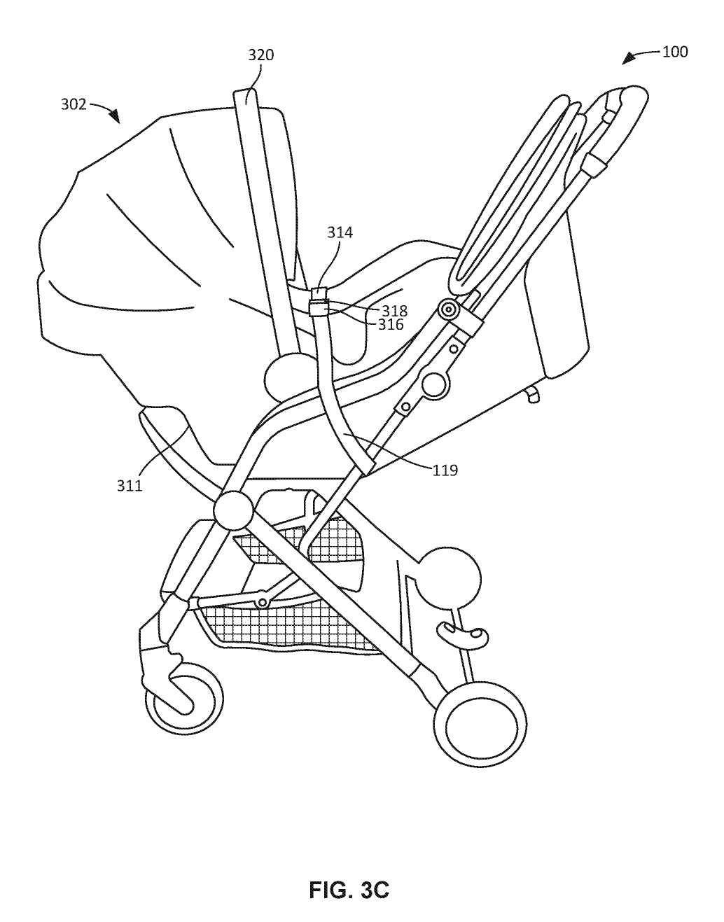

FIG. 3A shows a stroller system 300 including the example stroller 100 and an example car seat 302. The car seat 302 may be used to carry a child. The car seat 302 may be part of a car seat system that connects to a base that is disposed on a seat of a vehicle. FIG. 3A shows the leg rest 130 of the stroller 100 after being rotated upward (in the direction of arrow 304) to an upward position 306 (e.g., a third position). In the upward position 306, the leg rest 130 is angled upward (relative to a horizontal plane) from the seat bottom 124 (FIG. 1) of the seat 122. In the illustrated example, the leg rest 130 is angled at about 30° from horizontal. However, in other examples, the leg rest 130 may be angled more or less (e.g., 15°, 45°, etc.). In some examples, the leg rest 130 includes a latching mechanism that secures the leg rest 130 in each of the positions and/or otherwise prevents the leg rest 130 from rotating downward once in the corresponding position, as disclosed in further detail herein.

When the leg rest 130 is in the upward position 306, an upward facing u- or c-shaped contour 308 (represented as a dashed line) is formed by the leg rest 130, the seat bottom 124 (FIG. 1), and the seat back 126 (FIG. 1). In particular, the leg rest 130 is angled upward from one end of the seat bottom 124 (FIG. 1), and the seat back 126 (FIG. 1) is angled upward from the other end of the seat bottom (124). In this position, the leg rest 130 helps to cradle and support the car seat 302 in the stroller 100. In the illustrated example, the car seat 302 is shown above the seat 122. The car seat 302 may be lowered onto the seat 122 (in the direction of the arrow). The car seat 302 has a base or bottom 309, a front end 310, and a rear end 311 opposite the front end 310.

FIG. 3B shows the leg rest 130 in the upward position 306 and the example car seat 302 disposed on the seat 122. In the illustrated example, the car seat 302 is placed on the seat 122 in a rear-facing direction such that a child in the car seat 302 is facing the seat back 126 (FIG. 1). However, in other examples, the car seat 302 may be placed on the seat 122 in a forward-facing direction. In the illustrated example of FIG. 3B, the seat bottom 124 (FIG. 1) supports the bottom 309 of the car seat 302, the seat back 126 (FIG. 1) supports and/or blocks the front end 310 (FIG. 3A) of the car seat 302, and the leg rest 130 supports and/or blocks the rear end 311 of the car seat 302. As such, the seat back 126 (FIG. 1) and the leg rest 130 prevent or reduce forward or backward motion of the car seat 302. The leg rest 130 may bias (e.g., tilt) the car seat 302 toward the seat back 126 (FIG. 1), and the seat back 126 (FIG. 1) may bias or the car seat 302 toward the leg rest 130, which helps center, support, and stabilize the car seat 302 on the seat 122. In some examples, a portion of the bottom 309 of the car seat 302 also rests on or engages the leg rest 130 and/or the seat back 126 (FIG. 1).

In some examples, to further secure the car seat 302 to the stroller 100, a strap may be used to couple the car seat 302 and the stroller 100. For example, as shown in FIG. 3B, the stroller 100 includes the first strap 119 coupled (e.g., via a rivet) to one or more of the frame members on the first side 104 of the frame 102. In the illustrated example, the first strap 119 is coupled to a strut member 312 extending between the handle 108 and the rear leg 114. In other examples, the first strap 119 may be coupled to another frame member (e.g., to the side rail 110, to the rear leg 114, etc.). Similarly, a second strap 314 is coupled to one or more of the frame members on the second side 106 (FIG. 1) of the frame 102 (e.g., a corresponding strut on the second side 106 (FIG. 1) of the frame 102). A first connector 316 is coupled to the first strap 119 and a second connector 318 is coupled to the second strap 314. The first and second connectors 316, 318 releasably mate to connect the first and second straps 119, 314. The first and second connectors 316, 318 may be, for example, male and female connectors that can releasably connect. In some examples, the first and second connectors 316, 318 are a side release buckle. In other examples, other types of connectors may be implemented (e.g., hook and loop type fasteners, snaps, carabiners, etc.).

The first and second straps 119, 314 may be used to couple the car seat 302 and the stroller 100. For example, as shown in FIG. 3C, the first and second straps 119, 314 may be wrapped over a top of the car seat 302, and the first and second connectors 316, 318 may be connected. In some examples, the first and/or second straps 119, 314 may be adjusted (e.g., by pulling excess strap) to tighten the first and/or second straps 119, 314. In other examples, the first and second straps 119, 314 may be wrapped or routed through or along other sections of the car seat 302 (e.g., through a handle of the car seat 302, through a slot in the rear end 311 of the car seat 302, etc.). Therefore, the example stroller 100 can be used to receive and support various types (e.g., different shapes and sizes) of car seats. In this example, the frame 102 does not include mounting hubs or brackets like known strollers that require a matching connector on the car seat. In other examples, the frame 102 may include mounting hubs, but a car seat can still be disposed on the seat 122 and used with the stroller 100 without using the mounting hubs.

In another example, the first strap 119 may be looped through a handle bar 320 of the car seat 302 and connected back onto itself. For example, the first connector 316 may be implemented as a carabiner, which may be connected back onto the first strap 119. The second strap 314 may be similarly looped through the handle bar 320 and connected back onto itself. In such an example, the first and second straps 119, 314 do not connect to each other, but instead connect independently to the car seat 302.

In other examples, a single strap may be utilized. For example, a single strap, such as the first strap 119, may be coupled to one of the first or second sides 104, 106 of the frame 102. In such an example, the single strap may be wrapped over the top of the car seat 302. A first connector (e.g., the first connector 316) can be coupled to the single strap and can be used to connect the single strap to the other side of the frame 102 (e.g., to a corresponding connector mounted on the frame 102).

Additionally or alternatively, one or more strap(s) may be included as part of the car seat 302. For example, the car seat 302 may include one or more straps (e.g., two straps similar to the first and second straps 119, 314). The strap(s) may be coupled (e.g., fixed coupled with a rivet) to the car seat 302. Once the car seat 302 is set on the stroller 100, the strap(s) can be wrapped beneath the seat bottom 124 and/or another part of the frame 102 of the stroller 100 and connected to each other or another part of the stroller 100 and/or the car seat 302 to secure the car seat 302 to the stroller 100. In other examples, other types of devices, such as one or more cables, can be used in addition to or as an alternative to the strap(s) to secure the car seat 302 to the stroller 100. Thus, various arrangements of one or more straps and/or cables can be used to secure the car seat 302 to the stroller 100.

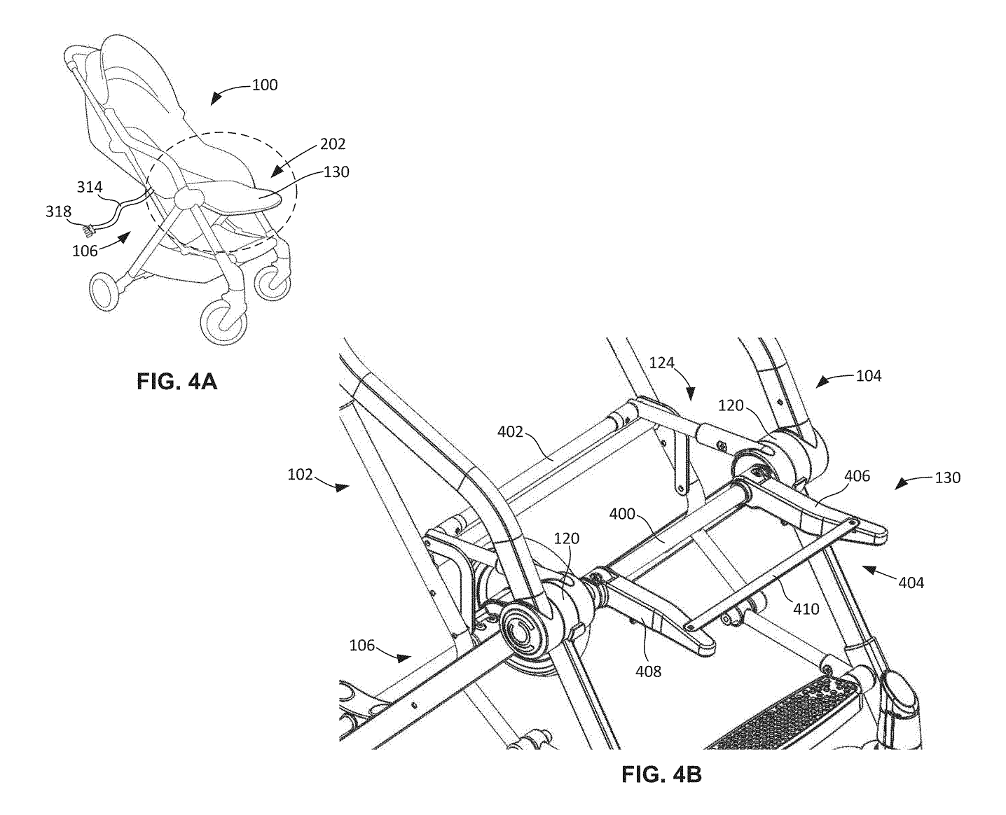

FIG. 4A is a side perspective view of the example stroller 100 showing the leg rest 130 in the extended position 202. The second strap 314 and second connector 318 are shown as coupled to the second side 106 of the stroller 100. FIG. 4B shows the portion of the stroller 100 encircled in FIG. 4A with the soft goods 128 (FIG. 1) removed to expose a portion of the frame 102 (e.g., an internal support frame) that forms at least part of the seat bottom 124 and the leg rest 130.

In the illustrated example of FIG. 4B, the frame 102 includes a cross-bar 400 extending between the first and second sides 104, 106 (e.g., between the hubs 120). The cross-bar 400 and a rear extending seat frame 402 form an internal support frame for the seat bottom 124. In other words, the cross-bar 400 and the rear extending seat frame 402 support the seat bottom 124. In this example, the cross-bar 400 remains stationary with the hubs 120 and does rotate in conjunction with the leg rest 130.

In the illustrated example, the leg rest 130 includes an internal support frame 404 that is rotatably coupled to the cross-bar 400. The cross-bar 400 corresponds to and forms the front 132 (FIG. 1) (e.g., a front or forward edge) of the seat bottom 124. In the illustrated example, the internal support frame 404 of the leg rest 130 includes a first arm 406 and a second arm 408 that are coupled to and extending outward from the cross-bar 400. The first and second arms 406, 408 are spaced apart from each other. The first and second arms 406, 408 are rotatably coupled to the cross-bar 400 (i.e., the first and second arms 406, 408 rotate around the cross-bar 400), which enables the leg rest 130 to rotate upward and downward relative to the seat bottom 124. In the illustrated example, the internal support frame 404 of the leg rest 130 includes a transverse support 410 coupled to and extending between the first arm 406 and the second arm 408 (e.g., near the distal ends of the first and second arms 406, 408). In some examples, the transverse support 410 forms a forward edge or end of the leg rest 130. In this example, the transverse support 410 is spaced apart from and parallel to the cross-bar 400. The soft goods 128, when coupled to the frame 102, covers at least a portion of the first and second arms 406, 408 and the transverse support 410.

FIG. 5 is a bottom perspective view of the internal support frame 404 of the leg rest 130. The soft goods 128 (FIG. 1) has been removed from the internal support frame 404. FIG. 5 shows the leg rest 130, including the first and second arms 406, 408 and the transverse support 410, the cross-bar 400, and the hubs 120.

As disclosed above, in some examples, the leg rest 130 is lockable in one or more positions (e.g., tilt angles). To release the leg rest 130 and enable the leg rest 130 to rotate to another position, the leg rest 130 includes a first tab 500 (e.g., a trigger). In the illustrated example, the first tab 500 is moveably coupled to the first arm 406. In some examples, when the first tab 500 is activated (e.g., moved), the leg rest 130 is released and can be moved to another position. For example, the first tab 500 can be displaced outward (away from the cross-bar 400) along the first arm 406 to unlock rotation of the leg rest 130 and can be displaced inward (toward the cross-bar 400) along the first arm 406 to lock rotation of the leg rest 130.

In the illustrated example, the first tab 500 extends from a bottom side of the first arm 406. The first tab 500 may remain exposed when the soft goods 128 (FIG. 1) is attached to the frame 102 and the internal support frame 404. A user can access the first tab 500 by placing the user's hand beneath the leg rest 130.

In the illustrated example, the leg rest 130 includes a first toothed hub 502 (e.g., a ratchet wheel) that is coupled to the cross-bar 400. The first toothed hub 502 remains stationary relative to the cross-bar 400. The first arm 406 rotates about the first toothed hub 502 on the cross-bar 400. The first toothed hub 502 defines one or more locking positions of the leg rest 130 based on positions of one or more teeth (e.g., ledges or steps) on an outer radius of the first toothed hub 502. In some examples, the first toothed hub 502 acts as a ratcheting mechanism that allows rotation in one direction (e.g., an upward rotation direction) but restricts motion in the opposite direction (e.g., a downward direction) unless unlocked or released by the first tab 500. In other words, in some examples, the leg rest 130 can be rotated upward through the one or more positions. However, after reaching each position, the leg rest 130 is locked or otherwise prevented from rotating downward unless the first tab 500 is activated (e.g., moved or pulled outward).

In the illustrated example, a second tab 504 is movably coupled to the second arm 408 and interfaces with a second toothed hub 506 on the cross-bar 400 for locking and releasing the second arm 408. The second tab 504 and the second toothed hub 506 operate in substantially the same manner as the first tab 500 and the first toothed hub 502. Therefore, to avoid redundancy, a description of this interaction is not repeated. Thus, in some examples, to release the leg rest 130, a user activates (e.g., pulls) both the first and second tabs 500, 504 simultaneously. Once the first and second tabs 500, 504 are pulled, the leg rest 130 can be rotated downward. In other examples, the second tab 504 and the second toothed hub 506 are not included. Instead, only the first tab 500 and the first toothed hub 502 are utilized to lock or release the leg rest 130, and the second arm 408 rotates freely on the cross-bar 400 (e.g., acts as a follower).

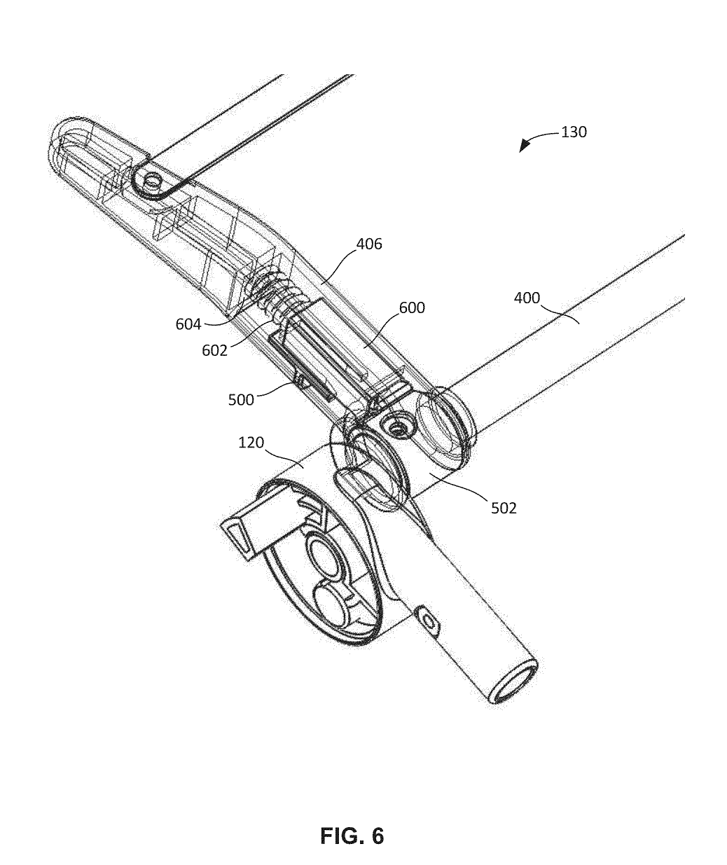

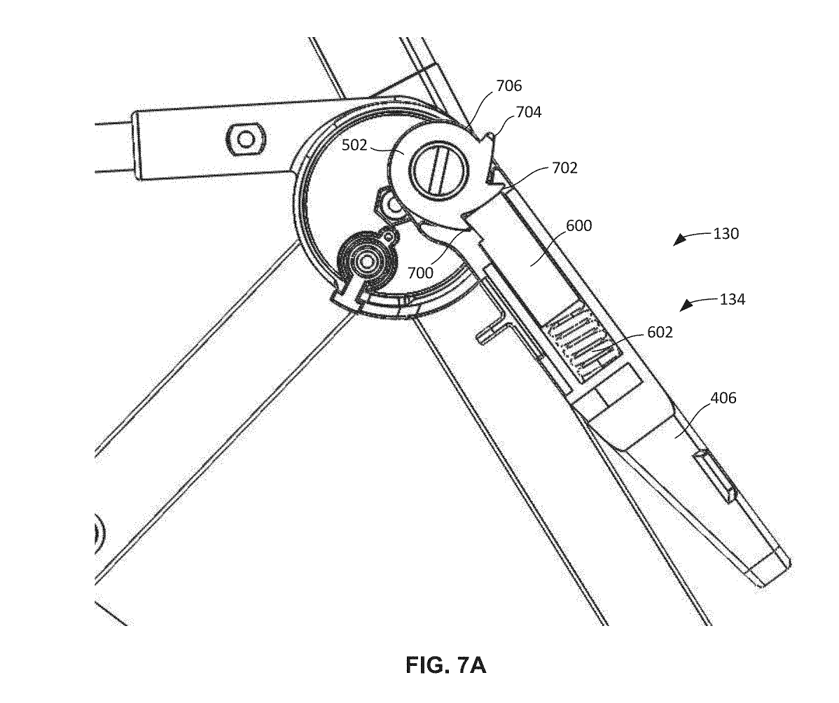

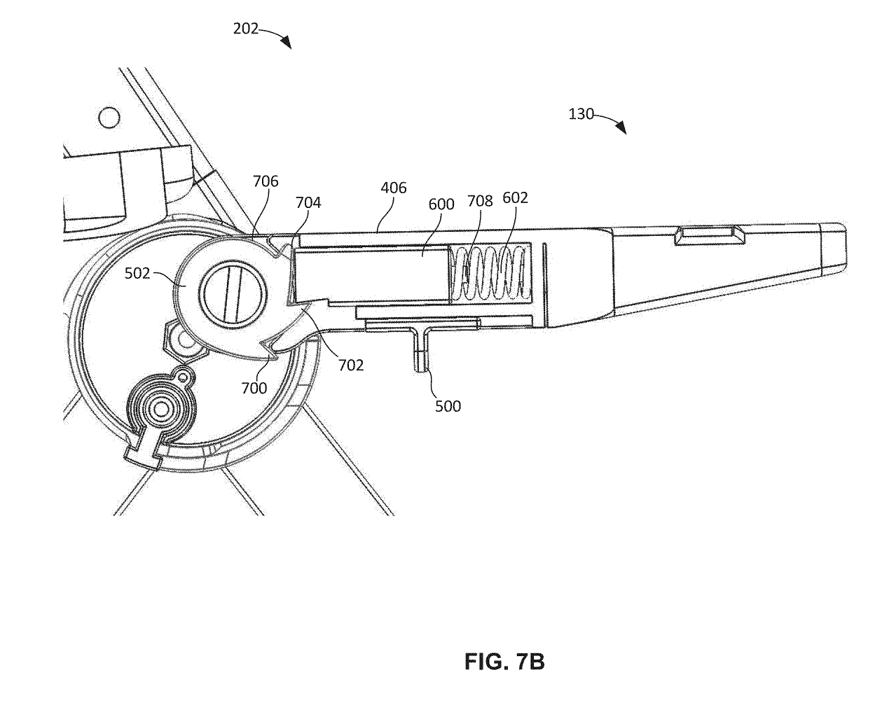

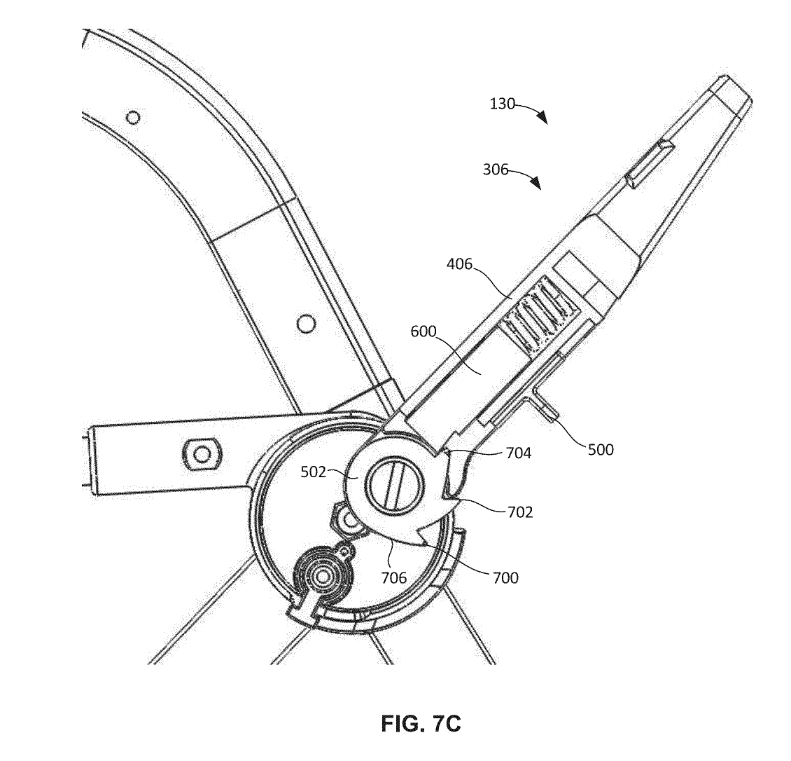

FIG. 6 is a perspective view of the first arm 406, the first toothed hub 502, the cross-bar 400, and the hub 120. In FIG. 6, the first arm 406 is shown as transparent to expose the internal structures. As shown in FIG. 6, the first tab 500 is coupled to a block 600 that is slidably coupled to the first arm 406. In the illustrated example, the block 600 is disposed within the first arm 406. The block 600 is engaged with and slides along the first toothed hub 502 as the first arm 406 is rotated upward or downward. The block 600 engages one of the teeth associated with the first toothed hub 502 (the engagement further described in conjunction with FIGS. 7A-7C) to promote locking of the leg rest 130.

To ensure engagement of the block 600 and the first toothed hub 502 occurs, the leg rest 130 includes a spring 602 (e.g., a compression spring). The spring 602 biases the block 600 toward the first toothed hub 502 and into engagement with the first toothed hub 502. In the illustrated example, the spring 602 is disposed between the block 600 and a wall 604 in the first arm 406. In some examples, the spring 602 is centered about a spring rod (the spring rod 708 shown in FIG. 7B) on the block 600. In other examples, other types of springs or biasing members may be utilized. A user may pull the first tab 500 to move the block 600 away from the first toothed hub 502 (e.g., using a sufficient force that overcomes the force applied by the spring 608).

FIGS. 7A, 7B, and 7C are side views of the first arm 406 and the first toothed hub 502 showing the leg rest 130 in the lowered position 134 (e.g., the first position), the extended position 202 (e.g., the second position), and the upward position 306 (e.g., the third position), respectively.

In the illustrated example of FIGS. 7A-7C, the first toothed hub 502 includes a first tooth 700 (associated with the leg rest 130 in the lowered position 134), a second tooth 702 (associated with the leg rest 130 in the extended position 202), and a third tooth 704 (associated with the leg rest 130 in the upward position 306). The teeth 700, 702, 704 are ledges or steps formed in an outer surface 706 of the first toothed hub 502. While in this example the first toothed hub 502 includes three teeth, in other examples the first toothed hub 502 can include fewer teeth (e.g., two teeth, one tooth) or more teeth (e.g., four teeth, five teeth, etc.), which may be used to lock the leg rest 130 in other positions.

As shown in FIG. 7A, the block 600 is engaged the first tooth 700 of the first toothed hub 502, which corresponds to the lowered position 134 of the leg rest 130. In this position, the leg rest 130 is prevented from rotating further downward (in the clockwise direction of FIG. 7A). In the lowered position 134, the leg rest 130 can be rotated upward (in the counter-clockwise direction in FIG. 7A) to either of the extended position 202 (FIG. 7B) or the upward position 306 (FIG. 7C). As the first arm 406 is rotated upward (counter-clockwise), the block 600 slides along the outer surface 706 of the first toothed hub 502. The block 600 is biased toward the first toothed hub 502 via the spring 602. Once the block 600 slides past the second tooth 702, the block 600 moves radially inward to the position shown in FIG. 7B.

Referring to FIG. 7B, the block 600 is engaged with the second tooth 702 of the first toothed hub 502, which corresponds to the extended position 202 of the leg rest 130. The block 600 is engaged with the second tooth 702, which prevents first arm 406 from rotating downward (in the clockwise direction in FIG. 7B). Thus, the leg rest 130 is locked in the extended position 202. From this position, the leg rest 130 can be rotated upward (in the counter-clockwise direction in FIG. 7B). When the leg rest 130 is rotated upward, the block 600 slides past the third tooth 704 to the position shown in FIG. 7C, disclosed below. However, to rotate the leg rest 130 downward to the lowered position 134 (in the clockwise direction in FIG. 7B), a user can pull the first tab 500 outward (to the right in FIG. 7B, away from the first toothed hub 502), which moves block 600 the away from the first toothed hub 502 far enough that the block 600 no longer engages the second tooth 702. Then, the first arm 406 (and, thus, the leg rest 130) can be rotated downward (e.g., back to the lowered position 134 (FIG. 7A)). If the leg rest 130 includes a second tab on the second arm 408, such as the second tab 504 (FIG. 5), then both the first and the second tabs 500, 504 must be pulled before rotating the leg rest 130 downward. The spring rod 708 is shown in FIG. 7B, which may center and support the spring 602 on the block 600.

Now referring to FIG. 7C, the block 600 is engaged with the third tooth 704 of the first toothed hub 502, which corresponds to the upward position 306 of the leg rest 130. The third tooth 704 prevents the first arm 406 and, thus, the leg rest 130 from rotating downward (in the clockwise direction in FIG. 7C). Thus, the leg rest 130 is locked in the upward position 306. To release the leg rest 130 and enable the leg rest 130 to be rotated downward (in the clockwise direction in FIG. 7C), a user can pull the first tab 500 outward, which moves block 600 the away from the first toothed hub 502 far enough that the block 600 no longer engages the third tooth 704. Then, the leg rest 130 can be rotated downward back to the extended position 202 (FIG. 7B), the lowered position 134 (FIG. 7A) and/or any position therebetween. As disclosed above, if the leg rest 130 includes a second tab on the second arm 408, such as the second tab 504 (FIG. 5), then both the first and the second tabs 500, 504 must be pulled before rotating the leg rest 130 downward.

While in this example the leg rest 130 is still rotatable upward in each position, in other examples, the leg rest 130 may include a feature (e.g., a tooth facing the opposite direction) that also blocks upward rotation of the leg rest 130 until the user activates the first tab 500.

As disclosed above, the second tab 504 and the second toothed hub 506 operate substantially the same to lock and release the second arm 408. Therefore, to release the leg rest 130 from one of the positions, a user pulls both the first and second tabs 500, 504 simultaneously.

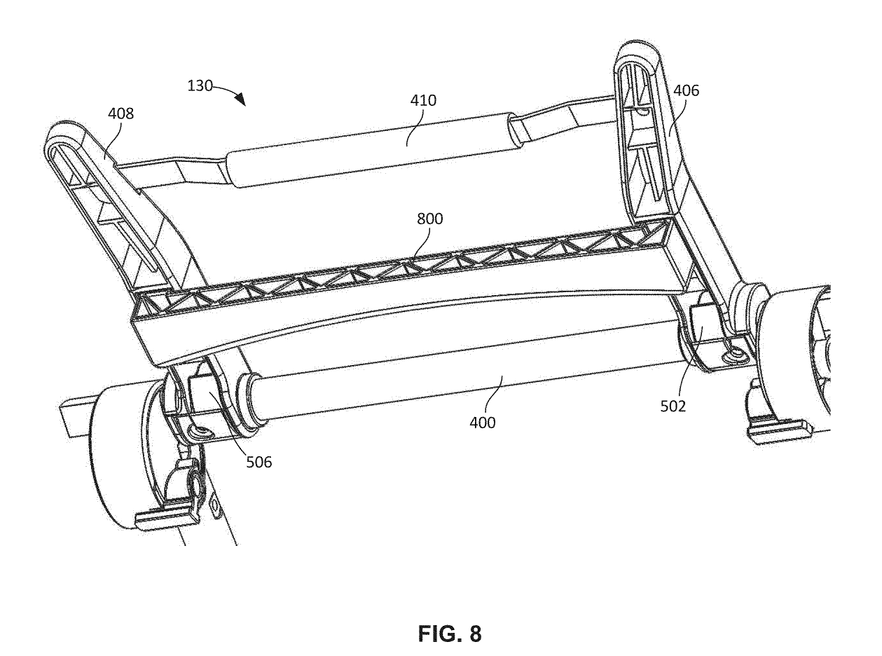

In other examples, a single hand action may be used to release the first and second arms 406, 408 simultaneously. For example, FIG. 8 shows an example in which a handle 800 is coupled to the block 600 (FIG. 6) in the first arm 406 and a corresponding block in the second arm 408. In this example, the handle 800 is disposed below the first and second arms 406, 408 and is connected to the first block 600 (FIG. 6) and the block in the second arm 408 along the bottom of the first and second arms 406, 408. In other examples, the handle 800 may extend through slots in the sides of the first and second arms 406, 408 and connect to the blocks in the first and second arms 406, 408. When the handle 800 is pulled outward (in a direction away from the cross-bar 400), the block 600 (FIG. 6) in the first arm 406 and the block in the second arm 408 are moved outward, away from the respective first and second toothed hubs 502, 506, thereby releasing the leg rest 130 and enabling the leg rest 130 to be rotated downward. Thus, the first and second arms 406, 408 are released simultaneously. The spring 602 (FIG. 6) in the first arm 406 and/or a similar spring in the second arm 408 bias the handle 800 inward (in a direction toward the cross-bar 400), such that the blocks engage the respective first and second toothed hubs 502, 506. If the handle 800 is implemented, an opening may be provided in the soft goods 128 to provide access to the handle 800. In other examples, instead of using the handle 800 to release the first and second arms 406, 408, the transverse support 410 may be used to release the blocks 600. In such an example, the transverse support 410 is coupled to and moveable with the block 600 (FIG. 6) (a first block) in the first arm 406 and a corresponding block (a second block) in the second arm 408.

In other examples, other types of mechanisms may be implemented to lock the leg rest 130 in one or more positions. For example, instead of using the block 600 and the first toothed hub 502, the first arm 406 may include a pin that is slidable into one or more openings (corresponding to one or more positions) formed in a hub on the cross-bar 400. This pin may be biased (e.g., via a spring) toward the cross-bar 400. The first tab 500 may be used to pull the pin out of an opening to release the leg rest 130 and enable the leg rest 130 to be rotated to another position. In other examples, other types and/or shapes of internal support frames and/or other types of locking or latching mechanisms can be implemented.

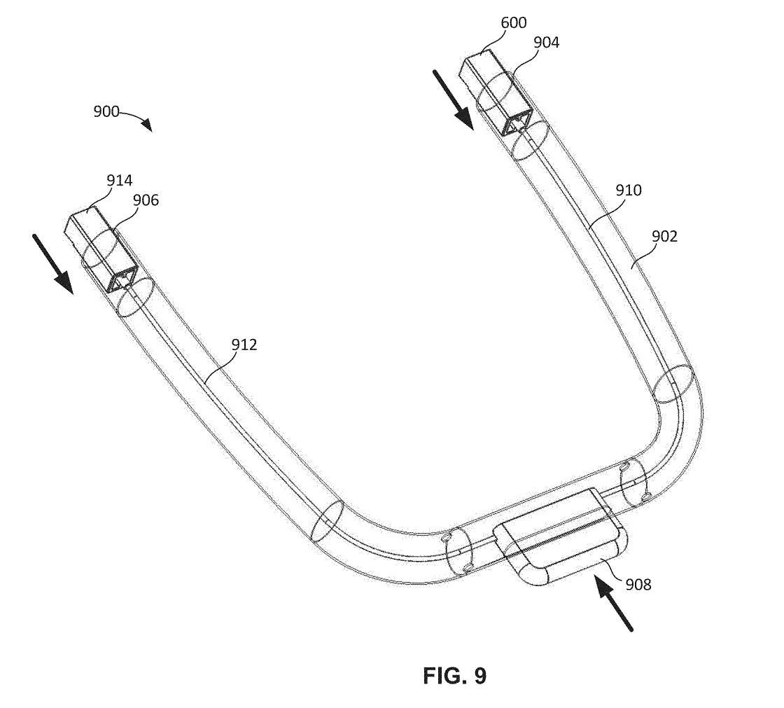

For example, FIG. 9 illustrates an alternative internal support frame 900 that can be implemented in connection with the leg rest 130 (FIG. 1). In this example, the internal support frame 900 includes a U-shaped tube 902. In FIG. 9, the U-shaped tube 902 is shown as transparent to expose one or more internal components. The U-shaped tube 902 can be used in place of the first and second arms 406, 408 (FIG. 4B) and the transverse support 410 (FIG. 4B). For example, a first end 904 of the U-shaped tube 902 can be coupled to the cross-bar 400 (FIG. 4B) and rotatable about the first toothed hub 502 (FIG. 5), and a second end 906 of the U-shaped tube 902 can be coupled to the cross-bar 400 (FIG. 4) and rotatable about the second toothed hub 506 (FIG. 5). In some example, the U-shaped tube 902 is constructed of a single unitary part or component (e.g., a single piece of tubular plastic). In other examples the U-shaped tube 902 is constructed of two or more components that are coupled together (e.g., via an adhesive, via friction fit, via a fastener, etc.). The U-shaped tube 902 may be at least partially covered by the soft goods 128 (FIG. 1), for example.

In the illustrated example of FIG. 9, a button 908 is coupled to the U-shaped tube 902 (e.g., at or near a center of the U-shaped tube 802). In the illustrated example, a first cable 910 is coupled between the button 908 and the block 600 (referred to in connection with FIG. 9 as the first block 600), and a second cable 912 is coupled between the button 908 and a second block 914. The first and second cables 910, 912 are disposed within the U-shaped tube 902. When the button 908 is pressed (in the direction of the arrow), the button 908 pulls the first and second cables 910, 912 inward (e.g., toward a center of the U-shaped tube 902), which pulls the first and second blocks 600, 914 away from the respective first and second toothed hubs 502, 506 (FIG. 5) (in the direction of the arrows), thereby releasing the leg rest 130 (FIG. 1) and enabling the leg rest 130 to be rotated to another position. In some examples, a spring is disposed in the U-shaped tube 902 to bias the button 908 outward, such that when the button 908 is released, the button 908 is moved outward and the first and second cables 910, 912 are relaxed. Also, when the button 908 is released, the first and second blocks 600, 914 are moved back (e.g., via the first spring 602 (FIG. 6) and a corresponding spring associated with the second block 914) into engaged with the first and second toothed hubs 502, 506 (FIG. 5) to lock the leg rest 130 in place.

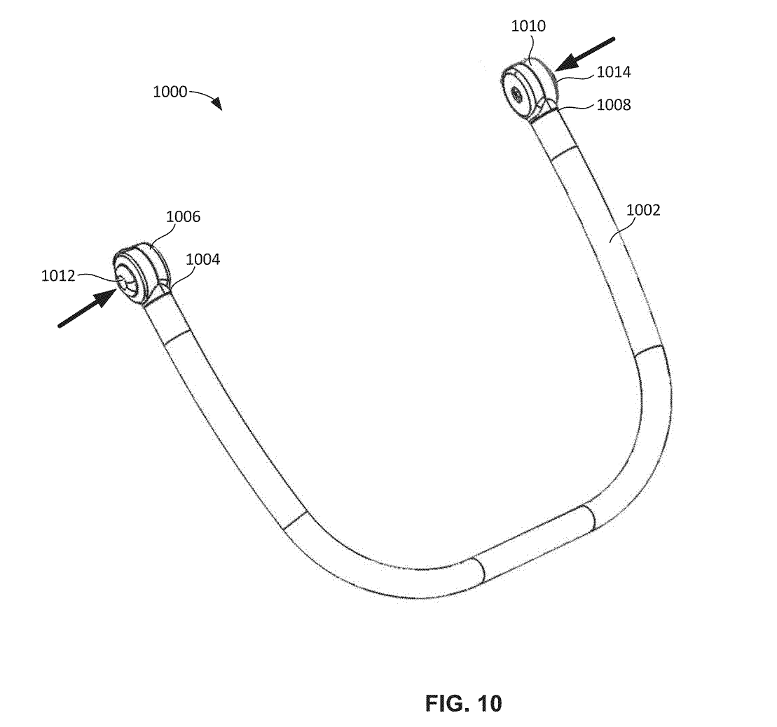

FIG. 10 illustrates another alternative internal support frame 1000 that can be implemented in connection with the leg rest 130 (FIG. 1). Similar to the example of FIG. 9, the internal support frame 1000 includes a U-shaped tube 1002. The U-shaped tube 1002 can be constructed of a single unitary part or component (e.g., a single piece of tubular plastic) or can be constructed of two or more components that are coupled together (e.g., via an adhesive, via friction fit, via a fastener, etc.). The U-shaped tube 1002 may be at least partially covered by the soft goods 128 (FIG. 1), for example.

In the illustrated example, a first end 1004 of the U-shaped tube 1002 is coupled to and rotatable about a first hub 1006, and a second end 1008 of the U-shaped tube 1002 is coupled to and rotatable about a second hub 1010. The first and second hubs 1006, 1010 may correspond to the hubs 120 (FIG. 4B), for example. In some examples, the first and second hubs 1006, 1010 include internal locking structures that releasably lock the U-shaped tube 1002 at various positions, such as a lowered position, an extended position, and an upward position, similar to the positions shown in FIGS. 1, 2, and 3A. In other examples, the U-shaped tube 1002 may be locked at more or fewer positions. In this example, a first release button 1012 is disposed on the first hub 1006 (e.g., on an outer-facing surface of the first hub 1006), and a second release button 1014 is disposed on the second hub 1010 (e.g., on an outer-facing surface of the second hub 1010). In some examples, to release the U-shaped tube 1002 from a locked position, the first and second release buttons 1012, 1014 are to pressed inward (in the direction of the arrows). In other words, the first and second release buttons 1012, 1014 may be pressed toward each other (e.g., in a direction along an axis of the cross-bar 400 (FIG. 4A)). In some examples, one or more springs may be incorporated into the first and/or second hubs 1006, 1010 to bias the first and second release buttons 1012, 1014 outward. In other examples, a locking mechanism may be incorporated into only one of the hubs, such as the first hub 1006. In such an example, only the first release button 1012 is to be pressed to release the U-shaped tube 1002.

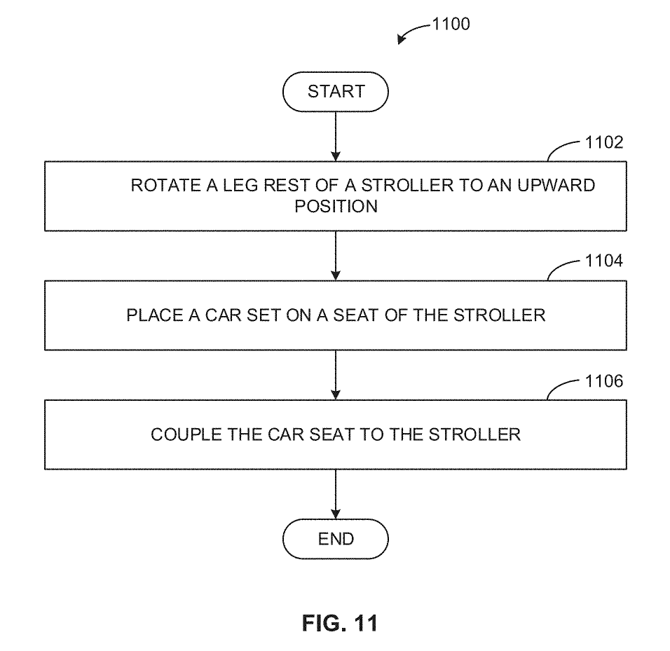

FIG. 11 is a flowchart representative of an example method 1100 for securing a car seat or other infant seat/carrier to a stroller having a movable leg rest. The example method 1100 is described in connection with the stroller 100 and the car seat 302 of the stroller system 300 of FIGS. 3A-3C. Although the example method 1100 is disclosed with respect to the flowchart illustrated in FIG. 11, other methods of affixing the car seat 302 to the stroller 100 may alternatively be used. For example, the order of execution of the blocks may be changed, and/or some of the blocks described may be changed, eliminated, or combined.

The example method 1100 of FIG. 11 begins at block 1102, where the leg rest 130 of the stroller 100 is rotated to the upward position 306, as illustrated in FIG. 3A. The leg rest 130 may be rotated from the lowered position 134 (FIG. 1) or the extended position 202 (FIG. 2), for example. In some examples, the leg rest 130 is freely rotatable upward, but is locked into position once in the upward position 306. For example, as shown in FIG. 7C, the block 600 in the first arm 406 engages the third tooth 704 on the first toothed hub 502 and prevents the leg rest 130 from rotating back downward. A similar block and tooth interaction may be formed between the second arm 408 and the second toothed hub 506. Thus, the leg rest 130 is locked in the upward position 306 and prevented from rotating back downwards via the first and second toothed hubs 502, 506 (FIG. 5). In other examples, only one of the arms may include a block. In other examples, other types of internal supports frames and/or latching mechanisms may be implemented, such as shown in FIGS. 9 and 10. In the upward position 306, the leg rest 130, the seat bottom 124, and the seat back 126 form the c-shaped contour 308 to support the car seat 302, as shown in FIG. 3A.

At block 1104, the car seat 302 is placed on the seat 122 of the stroller 100. For example, a bottom of the car seat 302 may be placed on the seat bottom 124. In some examples, the car seat 302 is placed on the seat 122 in a rear-facing direction. The seat back 126 and the leg rest 130 provide support for the car seat 302 and/or otherwise block the car seat 302 from moving (e.g., tilting) forward or backward.

In some examples, the car seat 302 may be coupled or secured to the stroller 100 at block 1106. For example, as shown in FIGS. 3B and 3C, the stroller 100 may include the first and second straps 119, 314 with the first and second connectors 316, 318 that can be used to fasten the car seat 302 to the stroller 100. In some examples, the first strap 119 and the second strap 314 are coupled, via the first and second connectors 316, 318, over a top of the car seat 302 while the car seat 302 is disposed on the seat 122. In other examples, the first and second straps 119, 314 may be routed through another part of the car seat 302. In still other examples, the car seat 302 may include one or more straps that can be connected to the stroller 100.

To remove the car seat 302 from the stroller 100, the operation of FIG. 11 may be performed in reverse. In particular, the car seat 302 can be decoupled from the seat 122 (e.g., by releasing the first and second connectors 316, 318 and removing the first and second straps 119, 314). Then, the leg rest 130 may then be rotated downward (e.g., by pulling the first and second tabs 500, 504 outward).

From the foregoing, it will be appreciated that example methods, apparatus, systems, and articles of manufacture have been disclosed that enable a car seat or other child carrier to be coupled to a stroller. Example strollers disclosed herein include a leg rest that is rotatable to a plurality of positions, including an upward position that creates a contour or cradle for supporting the car seat on the seat of the stroller. The leg rest provides additional support for the front or rear end (depending the orientation) of the car seat. The car seat may be further secured to the stroller using a strap, for example. By not requiring matching mounting hubs or brackets, the example stroller can be used to accommodate various types of car seats (e.g., of different shapes, sizes, etc.).

The following paragraphs provide various examples of the examples disclosed herein.

Example 1 includes a stroller including a frame, a seat carried by the frame, the seat having a seat bottom and a seat back, and a leg rest rotatably coupled to the seat bottom. The leg rest is rotatable to an upward position in which the leg rest is angled upward from the seat bottom and forms a c-shaped contour with the seat bottom and the seat back to support a car seat.

Example 2 includes the stroller of Example 1, wherein the frame includes a first side, a second side opposite the first side, and a cross-bar extending between the first side and the second side to support the seat bottom. The leg rest includes an arm extending from the cross-bar.

Example 3 includes the stroller of Example 2, wherein the leg rest is lockable in the upward position. The leg rest includes a tab coupled to the arm. The tab is to, when activated, release the leg rest from the upward position to enable the leg rest to be rotated downward.

Example 4 includes the stroller of Example 3, wherein the leg rest includes a toothed hub coupled to the cross-bar and a block slidably coupled to the arm. The tab is coupled to the block. The block is to engage teeth on the toothed hub and prevent the leg rest from rotating downward.

Example 5 includes the stroller of Example 4, wherein the tab extends from a bottom side of the arm.

Example 6 includes the stroller of Examples 4 or 5, wherein the leg rest further includes a spring to bias the block toward the toothed hub.

Example 7 includes the stroller of any of Examples 3-6, wherein the arm is a first arm and the tab is a first tab. The leg rest further includes a second arm spaced apart from the first arm and extending from the cross-bar and a second tab coupled to the second arm. The first and second tabs are to be activated simultaneously to release the leg rest from the upward position to enable the leg rest to be rotated downward.

Example 8 includes the stroller of Example 7, wherein the leg rest includes a transverse support extending between the first arm and the second arm. The transverse support is spaced apart from and parallel to the cross-bar.

Example 9 includes the stroller of Example 8, wherein the leg rest includes soft goods that covers at least a portion of the first and second arms and the transverse support.

Example 10 includes the stroller of any of Examples 1-9, wherein the leg rest is lockable in the upward position, an extended position, and a lowered position. In the extended position, the leg rest extends generally outward from the seat bottom, and in the lowered position, the leg rest extends downward from the seat bottom.

Example 11 includes the stroller of any of Examples 1-10, further including a strap coupled to the frame. The strap is to be wrapped around at least a portion of the car seat when the car seat is disposed on the seat.

Example 12 includes the stroller of any of Examples 1-11, wherein the frame does not include mounting hubs or brackets for attaching a car seat.

Example 13 includes a stroller system including a stroller including a seat having a seat bottom and a seat back and a leg rest rotatably coupled to the seat bottom. The leg rest is rotatable to an upward position in which the leg rest is angled upward from the seat bottom. The stroller system further includes a car seat to be placed on the seat bottom when the leg rest is in the upward position.

Example 14 includes the stroller system of Example 13, wherein the stroller includes a first strap with a first connector and a second strap with a second connector. The first and second straps are to be wrapped over a top of the car seat and the first and second connectors to be coupled to secure the car seat in the seat of the stroller.

Example 15 includes the stroller system of Example 14, wherein the stroller includes a frame having a first side and a second side opposite the first side. The first strap is coupled to the first side of the frame, and the second strap is coupled to the second side of the frame.

Example 16 includes the stroller system of Examples 14 or 15, wherein the first and second connectors are a side release buckle.

Example 17 includes the stroller system of any of Examples 13-16, wherein the leg rest is lockable in the upward position.

Example 18 a stroller including a frame, a seat carried by the frame, the seat having a seat bottom and a seat back, a leg rest rotatably coupled to a forward edge of the seat bottom, and means for locking the leg rest in an upward position in which the leg rest is angled upward from the seat bottom.

Example 19 includes the stroller of Example 18, further including means for releasing the means for locking to enable the leg rest to be rotated downward.

Example 20 includes the stroller of Examples 18 or 19, further including means for coupling a car seat to the stroller while the car seat is disposed on the seat.

Example 21 includes a method including rotating a leg rest of a stroller to an upward position. The stroller has a seat with a seat bottom and a seat back. The leg rest is rotatably coupled to the seat bottom. In the upward position, the leg rest is angled upward from the seat bottom and forms a c-shaped contour with the seat bottom and the seat back. The method also includes placing a car seat on the seat of the stroller.

Example 22 includes the method of Example 21, further including coupling the car seat to the stroller.

Example 23 includes the method of Example 22, wherein the stroller includes a first strap with a first connector and a second strap with a second connector, and wherein the coupling of the car seat to the stroller includes coupling the first and second straps, via the first and second connectors, over a top of the car seat while the car seat is disposed on the seat of the stroller.

Although certain example methods, apparatus, systems, and articles of manufacture have been disclosed herein, the scope of coverage of this patent is not limited thereto. On the contrary, this patent covers all methods, apparatus, systems, and articles of manufacture fairly falling within the scope of the claims of this patent.

What is claimed is:

1. A stroller comprising:
a frame;
a seat carried by the frame, the seat having a seat bottom and a seat back; and
a leg rest rotatably coupled to the seat bottom, the leg rest rotatable to an upward position in which the leg rest is angled upward from the seat bottom and forms a c-shaped contour with the seat bottom and the seat back to support a car seat.

2. The stroller of claim 1, wherein the frame includes a first side, a second side opposite the first side, and a cross-bar extending between the first side and the second side to support the seat bottom, the leg rest including an arm extending from the cross-bar.

3. The stroller of claim 2, wherein the leg rest is lockable in the upward position, the leg rest including a tab coupled to the arm, the tab to, when activated, release the leg rest from the upward position to enable the leg rest to be rotated downward.

4. The stroller of claim 3, wherein the leg rest includes:
a toothed hub coupled to the cross-bar; and
a block slidably coupled to the arm, the tab coupled to the block, the block to engage teeth on the toothed hub and prevent the leg rest from rotating downward.

5. The stroller of claim 4, wherein the tab extends from a bottom side of the arm.

6. The stroller of claim 4, wherein the leg rest further includes a spring to bias the block toward the toothed hub.

7. The stroller of claim 3, wherein the arm is a first arm and the tab is a first tab, the leg rest further including:
a second arm spaced apart from the first arm and extending from the cross-bar; and
a second tab coupled to the second arm, the first and second tabs to be activated simultaneously to release the leg rest from the upward position to enable the leg rest to be rotated downward.

8. The stroller of claim 7, wherein the leg rest includes a transverse support extending between the first arm and the second arm, the transverse support spaced apart from and parallel to the cross-bar.

9. The stroller of claim 8, wherein the leg rest includes soft goods that covers at least a portion of the first and second arms and the transverse support.

10. The stroller of claim 1, wherein the leg rest is lockable in the upward position, an extended position, and a lowered position, in the extended position, the leg rest extends generally outward from the seat bottom, and in the lowered position, the leg rest extends downward from the seat bottom.

11. The stroller of claim 1, further including a strap coupled to the frame, the strap to be wrapped around at least a portion of the car seat when the car seat is disposed on the seat.

12. The stroller of claim 1, wherein the frame does not include mounting hubs or brackets for attaching a car seat.

13. A stroller system comprising:
a stroller including:
a seat having a seat bottom and a seat back; and
a leg rest rotatably coupled to the seat bottom, the leg rest rotatable to an upward position in which the leg rest is angled upward from the seat bottom; and
a car seat to be placed on the seat bottom when the leg rest is in the upward position.

14. The stroller system of claim 13, wherein the stroller includes a first strap with a first connector and a second strap with a second connector, the first and second straps to be wrapped over a top of the car seat and the first and second connectors to be coupled to secure the car seat in the seat of the stroller.

15. The stroller system of claim 14, wherein the stroller includes a frame having a first side and a second side opposite the first side, the first strap coupled to the first side of the frame, the second strap coupled to the second side of the frame.

16. The stroller system of claim 14, wherein the first and second connectors are a side release buckle.

17. The stroller system of claim 13, wherein the leg rest is lockable in the upward position.

18. A stroller comprising:
a frame;
a seat carried by the frame, the seat having a seat bottom and a seat back;
a leg rest rotatably coupled to a forward edge of the seat bottom; and
means for locking the leg rest in an upward position in which the leg rest is angled upward from the seat bottom.

19. The stroller of claim 18, further including means for releasing the means for locking to enable the leg rest to be rotated downward.

20. The stroller of claim 18, further including means for coupling a car seat to the stroller while the car seat is disposed on the seat.
